(19) United States
(12) Patent Application Publication
(10) Pub. No.: US 2013/0320856 A1
(43) Pub. Date: Dec. 5, 2013

(54) LOAD DRIVING APPARATUS RELATING TO LED LAMP AND METHOD THEREOF AND ILLUMINATION APPARATUS USING THE SAME

(71) Applicant: BEYOND INNOVATION TECHNOLOGY CO., LTD., Taipei City (TW)

(72) Inventors: Chiu-Yuan Lin, Taipei City (TW); Chen-Lung Kao, Taipei City (TW)

(73) Assignee: BEYOND INNOVATION TECHNOLOGY CO., LTD., Taipei City (TW)

(21) Appl. No.: 13/798,092

(22) Filed: Mar. 13, 2013

(30) Foreign Application Priority Data
Jun. 1, 2012 (TW) 101119820

(51) Int. Cl. H05B 33/08

(52) U.S. Cl. CPC H05B 33/089
USPC 315/119

(57) ABSTRACT

The disclosure provides a load driving apparatus relating to an LED lamp and a method thereof and an illumination apparatus using the same. The disclosure can use a low-pass filter to filter out the high-frequency PWM signal output from the control chip and to provide a DC low voltage level to the PWM dimming pin of the control chip when the LED lamp gets short circuit. In this way, the control chip is able to entirely stop outputting the PWM signal in response to the DC low voltage level provided by the low-pass filter so as to avoid all the components in the load driving apparatus from damaging caused by the short circuit of the LED lamp.

### CROSS-REFERENCE TO RELATED APPLICATION

This application claims the priority benefit of Taiwan application serial no. 101119820, filed on Jun. 1, 2012. The entirety of the above-mentioned patent application is hereby incorporated by reference herein and made a part of this specification.

### BACKGROUND

1. Field of the Disclosure

The disclosure generally relates to a capacitive load driving technique, and more particularly, to a load driving apparatus relating to a light emitting diode lamp (LED lamp) and a method thereof and an illumination apparatus using the same.

2. Description of Related Art

With the progress of semiconductor technology, the light-emitting luminance and the light-emitting efficiency of an LED are continuously advanced. As a new type of cold light source, the LED has advantages of long lifetime, small size, electricity-saving, low pollution, high reliability and compatibility of mass production. The applicable field of the LED is very broad, for example, in the fields of illumination apparatus, liquid crystal display (LCD) or backlight source of large billboard, etc.

Taking the illumination apparatus with LED lamp as an example, where the driving apparatus for driving the LED lamp can adopt PWM-based (pulse width modulation-based) boost circuit or buck circuit. However, for the conventional illumination apparatus with LED lamp, no matter what kind of the architecture is adopted, the corresponding protection measures against LED lamp short circuit are imperfect, and that may cause damage of some component in the driving unit, and even may trigger burning partial components in the driving apparatus.

### SUMMARY OF THE DISCLOSURE

Accordingly, an exemplary embodiment of the disclosure is directed to a load driving apparatus, which includes a power conversion circuit, a control chip and a short-circuit protection circuit. The power conversion circuit is for receiving a DC input voltage and, in response to a PWM signal, providing a DC output voltage to an LED lamp. The control chip is coupled to the power conversion circuit and for producing the PWM signal to control the operation of the power conversion circuit, in which the control chip has an output pin for outputting the PWM signal and a PWM dimming pin for adjusting a duty cycle of the PWM signal. The short-circuit protection circuit is coupled between the output pin and the PWM dimming pin and for producing a short circuit protection signal to the PWM dimming pin when the LED lamp gets short circuit so as to make the output pin stop outputting the PWM signal.

In an exemplary embodiment of the disclosure, the power conversion circuit can be a buck circuit and the buck circuit can include a diode, an inductor, a power switch and a first resistor. The cathode of the diode is for receiving the DC input voltage and coupled to the first terminal of the LED lamp. The first terminal of the inductor is coupled to the anode of the diode, and the second terminal of the diode is coupled to the second terminal of the LED lamp. The drain of the power switch is coupled to the anode of the diode and the first terminal of the inductor, and the gate of the power switch is for receiving the PWM signal. The first resistor is coupled between the source of the power switch and a ground potential.

In an exemplary embodiment of the disclosure, the short-circuit protection circuit can be a low-pass filter and the low-pass filter includes a second resistor and a capacitor. The first terminal of the second resistor is coupled to the gate of the power switch and the output pin of the control chip, and the second terminal of the second resistor is coupled to the PWM dimming pin of the control chip. The first terminal of the capacitor is coupled to the second terminal of the second resistor and the PWM dimming pin of the control chip, and the second terminal of the capacitor is coupled to the ground potential.

Another exemplary embodiment of the disclosure provides an illumination apparatus, which includes an LED lamp and an above-mentioned load driving apparatus.

Yet another exemplary embodiment of the disclosure provides a load driving method, which includes: converting a DC input voltage into a DC output voltage in response to a PWM signal so as to provide the DC output voltage to an LED lamp; and stopping to produce the PWM signal in response to a low-pass filtering means when the LED lamp gets short circuit and further stopping to provide the DC output voltage to the LED lamp.

Based on the description above, the disclosure is able to use a low-pass filter (i.e., short-circuit protection circuit) to filter out the high-frequency PWM signal output from the control chip and to provide the DC low voltage level (i.e., short circuit protection signal) to the PWM dimming pin of the control chip when the LED lamp gets short circuit. In this way, the control chip is able to entirely stop outputting the PWM signal in response to the DC low voltage level provided by the low-pass filter so as to avoid all the components in the load driving apparatus from damaging caused by the short circuit of the LED lamp.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. It is intended that the scope of the disclosure is defined by the claims appended hereto.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic block diagram of an illumination apparatus 10 of an exemplary embodiment of the disclosure.

FIG. 2 is an implementation diagram of the illumination apparatus 10 in FIG. 1.

FIG. 3 is a flowchart of a load driving method relating to an LED lamp according to an exemplary embodiment of the disclosure.

### DESCRIPTION OF THE EMBODIMENTS

Reference will now be made in detail to the present embodiments of the disclosure, examples of which are illustrated in the accompanying drawings. Wherever possible, the same reference numbers are used in the drawings and the description to refer to the same or like components or parts.

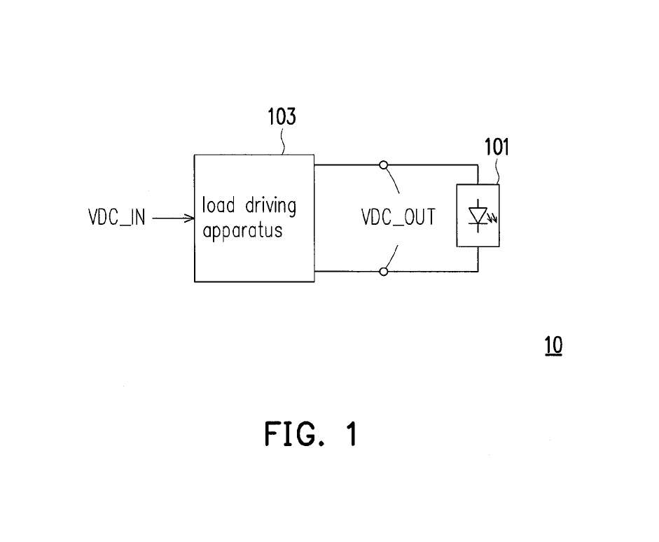

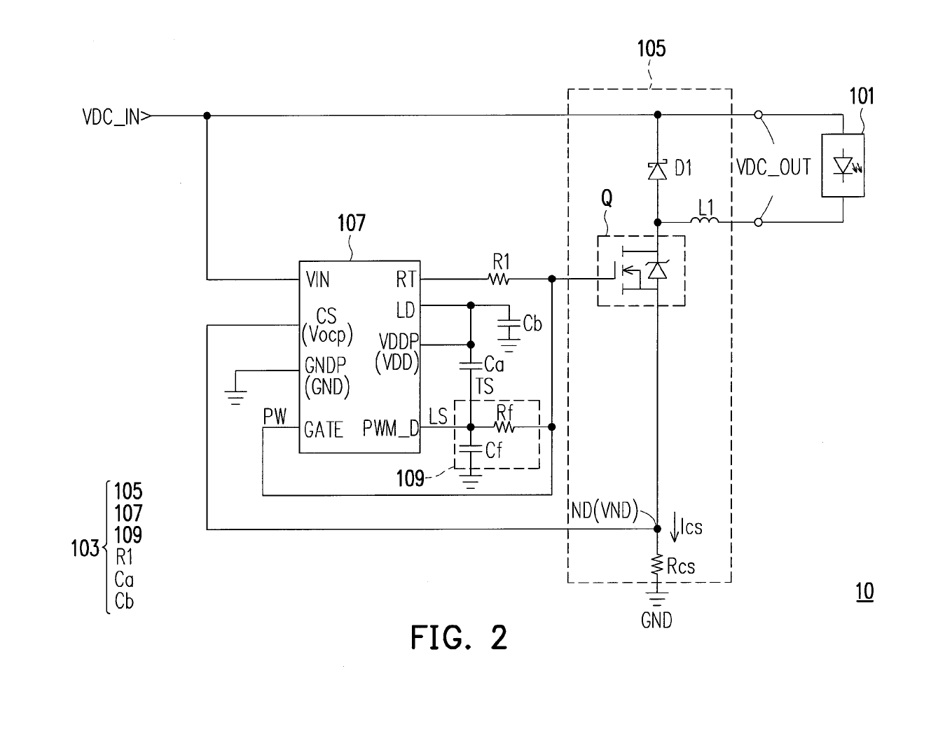

FIG. 1 is a schematic block diagram of an illumination apparatus 10 of an exemplary embodiment of the disclosure and FIG. 2 is an implementation diagram of the illumination apparatus 10 in FIG. 1. Referring to FIGS. 1 and 2, the illumination apparatus 10 includes an LED lamp 101 and a load driving apparatus 103. The LED lamp 101 is coupled to the load driving apparatus 103 for emitting light in response to a DC output voltage VDC_OUT come from the load driving apparatus 103. The load driving apparatus 103 is for receiving a DC input voltage VDC_IN after being rectified and filtered and, in response to a PWM control means, provides the DC output voltage VDC_OUT to the LED lamp 101.

In more details, the load driving apparatus 103 includes a power conversion circuit 105, a control chip 107, a short-circuit protection circuit 109, a resistor R1 and two capacitors Ca and Cb. The power conversion circuit 105 herein is for receiving the DC input voltage VDC_IN and, in response to a PWM signal PW output from the control chip 107, provides the DC output voltage VDC_OUT to the LED lamp 101.

In the exemplary embodiment, the power conversion circuit 105 can be, but not limited to, a buck circuit and includes a diode D1, for example but not limited to, a Schottky diode, an inductor L1, a (N-type) power switch Q and a resistor Rcs. The cathode of the diode D1 is for receiving the DC input voltage VDC_IN and coupled to the first terminal of the LED lamp 101. The first terminal of the inductor L1 is coupled to the anode of the diode D1 and the second terminal of the inductor L1 is coupled to the second terminal of the LED lamp 101.

The drain of the (N-type) power switch Q is coupled to the anode of the diode D1 and the first terminal of the inductor L1, while the gate of the (N-type) power switch Q is for receiving the PWM signal PW come from the control chip 107. The resistor Rcs is coupled between the source of the (N-type) power switch Q and a ground potential GND.

On the other hand, the control chip 107 is coupled to the power conversion circuit 105 for producing the PWM signal PW in response to the power supply demand of a load (i.e., the LED lamp 101) so as to control the operation of the power conversion circuit 105 (buck circuit). In the exemplary embodiment, the control chip 107 can have an output pin GATE for outputting the PWM signal PW and a PWM dimming pin PWM_D for adjusting the duty cycle of PWM signal PW, in which the duty cycle of PWM signal PW will determine the time ratio of turning on the LED lamp 101 over turning off the LED lamp 101 (time ratio of ON/OFF). The longer the ‘ON’ duration, the higher the luminance of the LED lamp 101 is, on contrary, the longer the ‘OFF’ duration, the lower the luminance of the LED lamp 101 is. Apparently, the luminance of the LED lamp 101 can be adjusted/determined by changing the duty cycle of the pulse signal at the PWM dimming pin PWM_D to be input to the control chip 107.

In addition, the short-circuit protection circuit 109 is coupled between the output pin GATE of the control chip 107 and the PWM dimming pin PWM_D for producing a short circuit protection signal LS (for example, a DC low voltage level) to the PWM dimming pin PWM D of the control chip 107 when the LED lamp 101 gets short circuit so as to make the output pin GATE of the control chip 107 entirely stop outputting the PWM signal PW.

Specifically, the short-circuit protection circuit 109 can be a low-pass filter (referring to the depiction thereof later). Accordingly, the short-circuit protection circuit 109 can include a (filtering) resistor Rf and a (filtering) capacitor Cf, in which the first terminal of the resistor Rf is coupled to the gate of the (N-type) power switch Q and the output pin GATE of the control chip 107, while the second terminal of the resistor Rf is coupled to the PWM dimming pin PWM_D of the control chip 107. In addition, the first terminal of the capacitor Cf is coupled to the second terminal of the resistor Rf and the PWM dimming pin PWM_D of the control chip 107, while the second terminal of the capacitor Cf is coupled to the ground potential GND.

The control chip 107 can further have a current detection pin CS, and the current detection pin CS of the control chip 107 would be coupled to the first terminal of the resistor Rcs (i.e., a node ND between the source of the (N-type) power switch Q and the first terminal of the resistor Rcs). In the exemplary embodiment, the control chip 107 can use the current detection pin CS to detect a current Ics flowing through the resistor Rcs and thus decide whether to start or activate an over-current protection mechanism to protect the load driving apparatus 103 from damaging caused by the over-current.

Specifically, an over-current protection reference voltage (for example, Vocp) is established inside the control chip 107. Once the voltage VND on the node ND (i.e., Rcs×Ics) is greater than the built-in over-current protection reference voltage Vocp, the control chip 107 would start or activate the over-current protection mechanism so as to gradually reduce the duty cycle of the PWM signal PW output from the output pin GATE of the control chip 107 until the voltage VND on the node ND (Rcs×Ics) is less than the built-in over-current protection reference voltage Vocp (i.e., no more over-current is produced).

Since the control chip 107 has the over-current protection function, when the LED lamp 101 gets short circuit, the voltage VND on the node ND (Rcs×Ics) quickly rises to reach the built-in over-current protection reference voltage Vocp. Thereafter, the duty cycle of the PWM signal PW output from the output pin GATE of the control chip 107 would gradually fall until to form a high-frequency PWM signal PW.

Thus, since the short-circuit protection circuit 109 is a low-pass filter by design, the short-circuit protection circuit 109 can continuously output the short circuit protection signal LS (i.e., the DC low voltage level) to the PWM dimming pin PWM_D of the control chip 107 (since a high-frequency signal is unable to pass through, which constitutes the major ground of designing the short-circuit protection circuit 109 as a low-pass filter), so that the output pin GATE of the control chip 107 can entirely stop outputting the PWM signal PW. In other words, at the time, the duty cycle of the PWM signal PW output from the output pin GATE of the control chip 107 is 0%, therefore, a complete circuit loop is unable to be formed between the load driving apparatus 103 and the LED lamp 101. As a result, all components in the load driving apparatus 103 are avoided from damaging due to the short circuit of the LED lamp 101.

On the other hand, the control chip 107 can have a voltage input pin VIN and an operation power pin VDDP. The control chip 107 receives the DC input voltage VDC_IN through the voltage input pin VIN and converts (for example, reducing voltage) the received DC input voltage VDC_IN so as to produce an operation voltage power VDD on the operation power pin VDDP. In addition, the control chip 107 certainly can have a grounding pin GNDP coupled to the ground potential GND.

The (trigger) capacitor Ca is coupled between the operation power pin VDDP and the PWM dimming pin PWM_D of the control chip 107 for providing a trigger signal TS to the PWM dimming pin PWM_D of the control chip 107 during the initial phase for the load driving apparatus 103 to start the LED lamp 101 (even during the initial phase of starting a new/without short circuit LED lamp, which is not shown in the figure), so that the output pin GATE of the control chip 107 outputs a (initial or predetermined) PWM signal PW for controlling the operation of the power conversion circuit 105.

The control chip 107 can further have a DC dimming pin LD. It should be noted that in the exemplary embodiment, the luminance of the LED lamp 101 is adjusted through the PWM dimming pin PWM_D of the control chip 107, thus, the DC dimming pin LD of the control chip 107 in the exemplary embodiment must be coupled to the ground potential GND through the capacitor Cb and be directly coupled to the operation power pin VDDP of the control chip 107 (i.e., for disabling the function of the DC dimming pin LD of the control chip 107).

It can be seen, in order to adjust the luminance of the LED lamp 101 through the DC dimming pin LD of the control chip 107, the PWM dimming pin PWM_D of the control chip 107 must change its wiring to be directly coupled to the operation power pin VDDP of the control chip 107 (i.e., for disabling the function of the PWM dimming pin PWM_D of the control chip 107) and the DC dimming pin LD of the control chip 107 can be changed to receive an adjusting voltage within a predetermined range (for example, but not limited to, 0-0.25V) for adjusting the luminance of the LED lamp 101.

Moreover, the control chip 107 can have a frequency setting pin RT. Thus in the exemplary embodiment, the resistor R1 can be coupled between the frequency setting pin RT and the output pin GATE of the control chip 107 for setting/adjusting the frequency of the PWM signal PW output from the output pin GATE of the control chip 107. However, in order to fix the frequency of the PWM signal PW output from the output pin GATE of the control chip 107, the frequency setting pin RT of the control chip 107 can change its wiring to be coupled to the ground potential GND through the resistor R1 (i.e., for disabling the function of the frequency setting pin RT of the control chip 107).

In this way, the disclosure can use the low-pass filter (short-circuit protection circuit 109) to filter out the high-frequency PWM signal PW output from the control chip 107 when the LED lamp 101 gets short circuit and can provide the DC low voltage level (short circuit protection signal LS) to the PWM dimming pin PWM_D of the control chip 107. As a result, the control chip 107 is able to entirely stop outputting the PWM signal PW in response to the DC low voltage level (short circuit protection signal LS) provided by the low-pass filter (short-circuit protection circuit 109), so that all components in the load driving apparatus 103 are avoided from damaging due to the short circuit of the LED lamp 101.

In addition, although the power conversion circuit 105 in the exemplary embodiment is in connection with a buck circuit as an example, but the disclosure does not limit to the buck circuit only. In other words, under the condition of keeping the object the above-mentioned exemplary embodiment unaffected, the power conversion circuit 105 can be other types of power conversion architecture, and the power conversion circuit 105 can be, for example, a boost circuit, a boost-buck circuit or the others, which depends on the real design/application requirement.

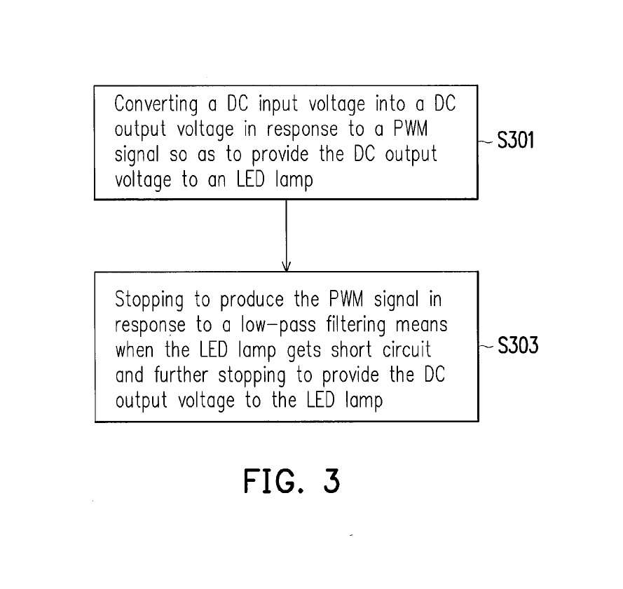

Based on the content disclosed and instructed by the above-mentioned exemplary embodiment, a load driving method is provided. FIG. 3 is a flowchart of a load driving method relating to an LED lamp according to an exemplary embodiment of the disclosure. Referring to FIG. 3, the load driving method of the exemplary embodiment includes:

Converting a DC input voltage into a DC output voltage in response to a PWM signal so as to provide the DC output voltage to an LED lamp (step S301); and

Stopping to produce the PWM signal in response to a low-pass filtering means when the LED lamp gets short circuit and further stopping to provide the DC output voltage to the LED lamp (step S303).

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. It is intended that the scope of the disclosure be defined by the claims appended hereto. In addition, any one of the embodiments or claims of the disclosure is not necessarily to achieve all of the above-mentioned objectives, advantages or features. The abstract of the disclosure is provided to comply with the rules requiring an abstract, which will allow a searcher to quickly ascertain the subject matter of the technical disclosure of any patent issued from this disclosure.

What is claimed is:

1. A load driving apparatus, comprising:
a power conversion circuit, for receiving a DC input voltage and, in response to a pulse width modulation signal, providing a DC output voltage to a light emitting diode lamp;
a control chip, coupled to the power conversion circuit and for producing the pulse width modulation signal to control the operation of the power conversion circuit, wherein the control chip has an output pin for outputting the pulse width modulation signal and a pulse width modulation dimming pin for adjusting a duty cycle of the pulse width modulation signal; and
a short-circuit protection circuit, coupled between the output pin and the pulse width modulation dimming pin and for producing a short circuit protection signal to the pulse width modulation dimming pin when the light emitting diode lamp gets short circuit so as to make the output pin stop outputting the pulse width modulation signal.

2. The load driving apparatus as claimed in claim 1, wherein the power conversion circuit at least is a buck circuit and the buck circuit comprises:
a diode, wherein cathode of the diode is for receiving the DC input voltage and coupled to first terminal of the light emitting diode lamp;
an inductor, wherein first terminal of the inductor is coupled to anode of the diode and second terminal of the diode is coupled to second terminal of the light emitting diode lamp;
a power switch, wherein drain of the power switch is coupled to the anode of the diode and the first terminal of the inductor, and gate of the power switch is for receiving the pulse width modulation signal; and
a first resistor, coupled between source of the power switch and a ground potential.

3. The load driving apparatus as claimed in claim 2, wherein the short-circuit protection circuit is a low-pass filter and the low-pass filter comprises:
a second resistor, wherein first terminal of the second resistor is coupled to the gate of the power switch and the output pin, and second terminal of the second resistor is coupled to the pulse width modulation dimming pin; and
a capacitor, wherein first terminal of the capacitor is coupled to the second terminal of the second resistor and the pulse width modulation dimming pin, and second terminal of the capacitor is coupled to the ground potential.

4. The load driving apparatus as claimed in claim 2, wherein:
the control chip further has a current detection pin coupled to the first terminal of the first resistor; and
the control chip detects current flowing through the first resistor through the current detection pin and thus decides whether to start or activate an over-current protection mechanism.

5. The load driving apparatus as claimed in claim 1, wherein the control chip further has an operation power pin, and the load driving apparatus further comprises:
a capacitor, coupled between the operation power pin and the pulse width modulation dimming pin for providing a trigger signal to the pulse width modulation dimming pin during an initial phase after starting the light emitting diode lamp so as to make the output pin output the pulse width modulation signal.

6. The load driving apparatus as claimed in claim 5, wherein the control chip further has:
a voltage input pin, wherein the control chip receives the DC input voltage through the voltage input pin and converts the received DC input voltage so as to produce an operation voltage power on the operation power pin; and
a grounding pin, coupled to the ground potential.

7. An illumination apparatus, comprising:
a light emitting diode lamp, used for emitting light in response to a DC output voltage; and
a load driving apparatus, comprising:
a power conversion circuit, for receiving a DC input voltage and, in response to a pulse width modulation signal, providing the DC output voltage to the light emitting diode lamp;
a control chip, coupled to the power conversion circuit and for producing the pulse width modulation signal to control the operation of the power conversion circuit, wherein the control chip has an output pin for outputting the pulse width modulation signal and a pulse width modulation dimming pin for adjusting a duty cycle of the pulse width modulation signal; and
a short-circuit protection circuit, coupled between the output pin and the pulse width modulation dimming pin and for producing a short circuit protection signal to the pulse width modulation dimming pin when the light emitting diode lamp gets short circuit so as to make the output pin stop outputting the pulse width modulation signal.

8. The illumination apparatus as claimed in claim 7, wherein the power conversion circuit at least is one buck circuit and the buck circuit comprises:
a diode, wherein cathode of the diode is for receiving the DC input voltage and coupled to first terminal of the light emitting diode lamp;
an inductor, wherein first terminal of the inductor is coupled to anode of the diode and second terminal of the diode is coupled to second terminal of the light emitting diode lamp;
a power switch, wherein drain of the power switch is coupled to the anode of the diode and the first terminal of the inductor, and gate of the power switch is for receiving the pulse width modulation signal; and
a first resistor, coupled between source of the power switch and a ground potential.

9. The illumination apparatus as claimed in claim 8, wherein the short-circuit protection circuit is a low-pass filter and the low-pass filter comprises:
a second resistor, wherein first terminal of the second resistor is coupled to the gate of the power switch and the output pin, and second terminal of the second resistor is coupled to the pulse width modulation dimming pin; and
a capacitor, wherein first terminal of the capacitor is coupled to the second terminal of the second resistor and the pulse width modulation dimming pin and second terminal of the capacitor is coupled to the ground potential.

10. The illumination apparatus as claimed in claim 8, wherein:
the control chip further has a current detection pin coupled to the first terminal of the first resistor; and
the control chip detects current flowing through the first resistor through the current detection pin and thus decides whether to start or activate an over-current protection mechanism.

11. The illumination apparatus as claimed in claim 7, wherein the control chip further has an operation power pin, and the load driving apparatus further comprises:
a capacitor, coupled between the operation power pin and the pulse width modulation dimming pin for providing a trigger signal to the pulse width modulation dimming pin during an initial phase after starting the light emitting diode lamp so as to make the output pin output the pulse width modulation signal.

12. The illumination apparatus as claimed in claim 11, wherein the control chip further has:
a voltage input pin, wherein the control chip receives the DC input voltage through the voltage input pin and converts the received DC input voltage so as to produce an operation voltage power on the operation power pin; and
a grounding pin, coupled to the ground potential.

13. A load driving method, comprising:
converting a DC input voltage into a DC output voltage in response to a pulse width modulation signal so as to provide the DC output voltage to a light emitting diode lamp; and
stopping to produce the pulse width modulation signal in response to a low-pass filtering means when the light emitting diode lamp gets short circuit and further stopping to provide the DC output voltage to the light emitting diode lamp.
